(19) United States
(12) Patent Application Publication
(10) Pub. No.: US 2012/0165467 A1
(43) Pub. Date: Jun. 28, 2012

(54) NEW POLYELECTROLYTE COMPLEXES AND THE USE THEREOF

(75) Inventors: Wilfried Lövenich, Bergisch-Gladbach (DE); Andreas Elschner, Mulheim (DE)

(73) Assignee: HERAEUS PRECIOUS METALS GmbH & Co. KG

(21) Appl. No.: 13/381,420

(22) PCT Filed: Jun. 30, 2010
(86) PCT No.: PCT/EP2010/003861

§ 371 Date: Mar. 2, 2012

Related U.S. Application Data
(60) Provisional application No. 61/253,618, filed on Oct. 21, 2009.

(30) Foreign Application Priority Data
Jul. 2, 2009 (DE) 10 2009 031 677.9

(51) Int. Cl. C08G 75/20; C09D 181/06; C08G 75/23

(52) U.S. Cl. 524/609; 525/535

(57) ABSTRACT

The invention relates to novel polyelectrolyte complexes of a functionalised polysulphone and a conductive polymer and to the use thereof.

The invention relates to novel polyelectrolyte complexes containing a functionalised polysulphone and a conductive polymer and to the use thereof.

Conductive polymers are becoming increasingly economically important, as polymers have advantages over metals with regard to processability, weight and the targeted setting of properties by chemical modification. Examples of known m-conjugated polymers are polypyrroles, polythiophenes, polyanilines, polyacetylenes, polyphenylenes and poly(p-phenylenevinylenes). Layers made of conductive polymers are widely used in industry, for example as polymeric counter electrodes in capacitors or for through-contacting of electronic printed circuit boards. Conductive polymers are produced chemically or by electrochemical oxidation from monomeric precursors, such as for example optionally substituted thiophenes, pyrroles and anilines and the respective optionally oligomeric derivatives thereof. Polymerisation by chemical oxidation, in particular, is widespread, as it can be carried out in a technically simple manner in a liquid medium or on a broad range of substrates.

A particularly important and industrially used polythiophene is poly(ethylene-3,4-dioxythiophene) (PEDOT or PEDT) which is described for example in EP 339 340 A2, which is produced by chemical polymerisation of ethylene-3,4-dioxythiophene (EDOT or EDT) and which displays in its oxidised form very high conductivities. An overview of numerous poly(alkylene-3,4-dioxythiophene) derivatives, in particular poly(ethylene-3,4-dioxythiophene) derivatives, the monomer building blocks, syntheses and applications thereof is provided by L. Groenendaal, F. Jonas, D. Freitag, H. Pielartzik & J. R. Reynolds, Adv. Mater. 12, (2000) pp. 481-494.

The dispersions, disclosed for example in EP 0440 957 B1, of PEDOT with polyanions, such as for example polystyrene sulphonic acid (PSSA), have become particularly industrially important. Transparent, conductive films can be produced from these dispersions; such films have found a large number of applications, for example as an antistatic coating or as a hole injection layer in organic light emitting diodes (OLEDs) as disclosed in EP 1227529 B1.

EDT is polymerised in this case in an aqueous solution of the polyanion, and a polyelectrolyte complex is formed. Cationic polythiophenes, which for charge compensation contain polymeric anions as counterions, are also often referred to by experts as polythiophene/polyanion complexes. On account of the polyelectrolyte properties of PEDT as the polycation and PSSA as the polyanion, this complex is not a genuine solution in this regard, but rather more a dispersion. To what extent polymers or parts of the polymers are in this case dissolved or dispersed depends on the ratio by mass of the polycation and the polyanion, on the charge density of the polymers, on the salt concentration of the environment and on the nature of the surrounding medium (V. Kabanov, Russian Chemical Reviews 74, 2005, 3-20). The transitions may be fluid in this regard. No distinction will therefore be drawn hereinafter between the terms “dispersed” and “dissolved”. No more is a distinction drawn between “dispersion” and “solution” or between “dispersing agent” and “solvent”. On the contrary, these terms will be used hereinafter as synonyms.

As described at the outset, complexes of PEDOT and PSSA have found a broad range of applications. Nevertheless, these complexes are distinguished by intrinsic high acidity. This is due to the high acidity of PSSA. The equivalent weight of PSSA is 184 g/mol. The pH value of PEDOT:PSSA dispersions is correspondingly low; for example, a typical PEDOT:PSSA dispersion, which is used as a hole injection layer in OLEDs, has a pH value of 1.5. This low pH value can lead, for example in OLEDs, to etching of the transparent electrode made of indium tin oxide (ITO). As a result, In and Sn ions are mobilised and can diffuse into adjacent layers (M. P. de Jong et al., Appl. Phys. Lett. 77, (2000), 2255-2257) and thus adversely affect the useful life of the OLEDs.

Si-Jeon Kim et al., Chem. Phys. Lett. 386, (2004), 2-7 and Jaengwan Chung et al., Organic Electronics 9, (2009), 869-872 have described how PSSA is thermally decomposed and loses sulphate in the process, i.e. PSSA is not stable. In OLEDs, for example, this sulphate can adversely affect the useful life of the OLEDs.

EP 1564250 A and EP 1546251 B1 have described mixtures of perfluorinated sulphonic acid polymers with conductive polymers as a hole injection layer in OLEDs. Using these mixtures for producing hole injection layers in OLEDs, it was possible to demonstrate that the presence of the fluorinated polymer leads to an improvement in the useful lives of the OLED. However, layers containing fluorinated polymers are distinguished by a high contact angle. This impedes the deposition of further solvent-based layers, as the large contact angle impedes the formation of films.

There was thus a need for novel complexes containing conductive polymers and polyanions. In particular, there was a need for complexes of this type in which the polyanions are distinguished by lower acidity compared to PSSA and increased stability. Furthermore, there was a need for complexes of this type which are suitable for producing hole injection layers for OLEDs, the layers being distinguished by a low contact angle and the OLEDs by long useful lives.

Now, it has surprisingly been found that complexes of conductive polymers and functionalised polysulphones as polyanions are suitable for producing transparent conductive films and these complexes are distinguished by high stability. Furthermore, it has been found that conductive films of this type are suitable as a hole injection layer in OLEDs, the useful life of OLEDs of this type being particularly long when the pH value of the dispersion is increased by adding base(s).

The subject matter of the present invention is thus a complex comprising at least one optionally substituted conductive polymer and at least one functionalised polysulphone, characterised in that the polysulphone is a polymer which contains an (—SO₂—) group (sulphone group) in its repeating units and in which this sulphone group is linked to two aromatic groups.

In a preferred embodiment of the present invention, the functionalised polysulphones contain recurring units of general formula (I)

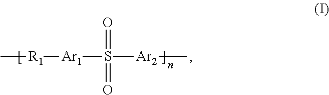

wherein
A₁ and A₂ may be the same or different, and are optionally substituted aromatics,
R₁ is an optionally substituted organic radical containing 0 to 80 carbon atoms or —SO₂— or —O— and
n is an integer from 5 to 50,000, preferably from 10 to 300,000, particularly preferably from 20 to 20,000.

Within the scope of the invention, aromatics are cyclic conjugated systems, preferably benzene, naphthalene, anthracene and biphenyl, particularly preferably benzene.

Furthermore, within the scope of the invention, an organic radical containing 0 to 80 carbon atoms is a compound composed for example of one or more of the following groups, wherein individual groups can also occur repeatedly in the radical. The groups in the radical R₁ include ether, sulphone, sulpholane, sulphide, ester, carbonate, amide, imide, aromatic groups—in particular phenylene, biphenylene and naphthalene—and also aliphatic groups, in particular methylene, ethylene, propylene and isopropylidene. The aromatic and aliphatic groups can additionally be substituted.

The term “substituted” as used in this sense and hereinafter refers, unless otherwise expressly stated, to a substitution with a group selected from the series consisting of alkyl, preferably C₁-C₂₀ alkyl; cycloalkyl, preferably a C₃-C₁₂ cycloalkyl; an aryl, preferably a C₆-C₁₄ aryl, a halogen, preferably Cl, Br or J; ether, thioether, disulphide, sulphoxide, sulphone, sulphonate, amino, aldehyde, keto, carboxylic acid ester, carboxylic acid, carbonate, carboxylate, phosphonic acid, phosphonate, cyano, alkylsilane and alkoxysilane groups and also carboxylamide groups.

C₁-C₂₀ alkyl represents linear or branched C₁-C₂₀ alkyl radicals such as for example methyl, ethyl, n- or iso-propyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl, n-heptadecyl, n-octadecyl, n-nonadecyl or n-eicosanyl; C₃-C₁₂ cycloalkyl radicals represents cycloalkyl radicals such as for example cyclopropyl, cyclobutyl, cyclopentyl, cyclohexyl, cycloheptyl, cyclooctyl, cyclononyl or cyclodecyl and a C₆-C₁₄ aryl represents C₆-C₁₄ aryl radicals such as phenyl or naphthyl.

The functionalised polysulphones within the scope of this invention are distinguished by a molecular weight (Mw) of from 5,000 to 5,000,000 g/mol, preferably by a molecular weight (Mw) of from 10,000 to 1,000,000 g/mol, particularly preferably of from 20,000 to 500,000 g/mol. These functionalised polysulphones are either commercially available or can be produced using known processes (Schuster et al. Macromolecules 2009, 42(8), 3129-3137; Blanco, J. F.; Nguyen, Q. T.; Schaetzel, P. Journal of Applied Polymer Science (2002), 84(13), 2461-2473; Monet, C.; Revilion, A.; Le Perchec, P.; Llauro, M. F.; Guyot, A. Polymer Bulletin (1982), 8(11-12), 511-17).

In a particularly preferred embodiment of the present invention, the functionalised polysulphones contain recurring units of general formula (II)

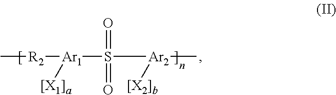

wherein
Ar₁ and Ar₂ may be the same or different, and represent an aromatic,
X₁ and X₂ may be the same or different and each represent a sulphonic acid, phosphonic acid, carboxylic acid, sulphonate, phosphonate or carbonate group,
a and b may be the same or different, and each independently of one another represent an integer or non-integer between 0 and 2, wherein non-integers mean that the aforementioned acid occurs not in each repeating unit, but only in the corresponding fraction of the repeating units,
R₂ has the same meaning as R₁, and
n is an integer from 5 to 50,000, preferably from 10 to 300,000, particularly preferably from 20 to 20,000.

The functionalisation of the polysulphonic acids containing recurring units of formula (II) can occur on all or else only on some of the corresponding repeating units, i.e. non-integers for a and b mean—including hereinafter—that the aforementioned acid occurs not in each repeating unit, but only in the corresponding fraction of the repeating units.

Most particularly preferably, the functionalised polysulphones are sulphonated polysulphonic acids, the production of which is described for example by Schuster et al. (Macromolecules 2009, 42(8), 3129-3137).

In a most particularly preferred embodiment of the invention, the functionalised polysulphones contain recurring units of general formula (IIa), in which the aromatic Ar₁ and Ar₂ represents in each case a benzene ring:

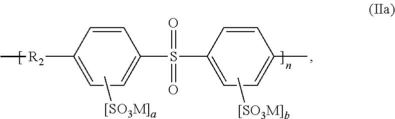

wherein
a, b and R₂ have the above-mentioned meaning, and
M is a metal cation or H, preferably Na, K, Li or H, particularly preferably H.

Within the scope of the invention, the sulphonated polysulphones according to general formula (IIa) will also be referred to as sulphonated polyphenylsulphones (s-PPS).

In a further most particularly preferred embodiment of the invention, the functionalised polysulphones contain recurring units of general formula (III), in which the repeating unit contains four benzene rings which are bridged via three sulphone groups and one ether group, wherein each benzene ring can carry sulphonic acid groups:

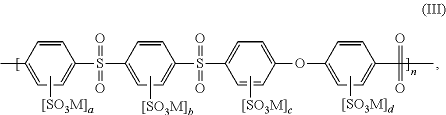

wherein
a, b, c and d may be the same or different, and each represent an integer or non-integer between 0 and 1, wherein non-integers mean that the aforementioned acid occurs not in each repeating unit, but only in the corresponding fraction of the repeating units,
M represents a metal cation or H, preferably Na, K, Li or H, particularly preferably H.

In a further most particularly preferred embodiment of the invention, the functionalised polysulphones contain recurring units of general formula (IV), in which the repeating unit likewise comprises four benzene rings which are bridged by one sulphone group, two ether groups and one alkylidene group, wherein each benzene ring can carry sulphonic acid groups:

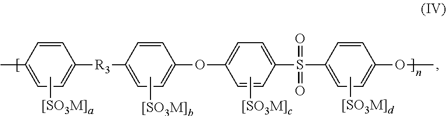

wherein
a, b, c, d and M likewise have the meaning mentioned for general formula (III), and
R₃ represents an alkylidene group, preferably isopropylidene.

In still a further most particularly preferred embodiment of the invention, the functionalised polysulphones contain recurring units of general formula (V), in which the repeating unit contains two benzene rings which are bridged by a sulphone group and ether group, wherein each benzene ring can carry sulphonic acid groups:

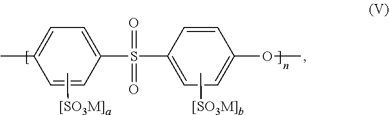

wherein
a and b may be the same or different, and each represent an integer or non-integer between 0 and 1, wherein non-integers mean that the aforementioned acid occurs not in each repeating unit, but only in the corresponding fraction of the repeating units,
M represents a metal cation or H, preferably Na, K, Li or H, particularly preferably H,
   or the functionalised polysulphones contain recurring units of general formula (VI), in which the repeating unit likewise comprises two benzene rings which are bridged by two sulphone groups, wherein each benzene ring can carry sulphonic acid groups:

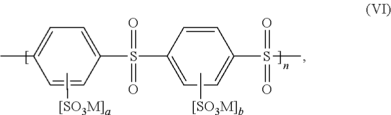

wherein a, b and M likewise have the meaning mentioned for general formula (V).

Within the scope of the invention, the term “functionalised polysulphones” also refers to mixtures or copolymers of the above-cited functionalised polysulphones.

In addition to the above-described polyanions, the complex according to the invention comprises at least one optionally substituted conductive polymer as the polycation. Examples of conductive polymers of this type are optionally substituted polyanilines, optionally substituted polypyrroles and optionally substituted polythiophenes.

In a preferred embodiment of the invention, the conductive polymers are optionally substituted polythiophenes containing recurring units of general formula (VII),

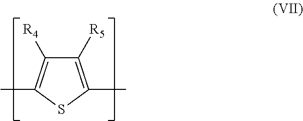

wherein
R₄ and R₅ each independently of one another represent H, an optionally substituted C₁-C₁₈ alkyl radical or an optionally substituted C₁-C₁₈ alkoxy radical, R₄ and R₅ together represent an optionally substituted C₁-C₈ alkylene radical, wherein one or more C atom(s) can be replaced by one or more same or different heteroatoms selected from O or S, preferably a C₁-C₈ dioxyalkylene radical, an optionally substituted C₁-C₈ oxythiaalkylene radical or an optionally substituted C₁-C₈ dithiaalkylene radical, or an optionally substituted C₁-C₈ alkylidene radical, wherein optionally at least one C atom is replaced by a heteroatom selected from O or S.

Particularly preferably, these are polythiophenes of the type containing recurring units of general formula (VII-a) and/or (VII-b)

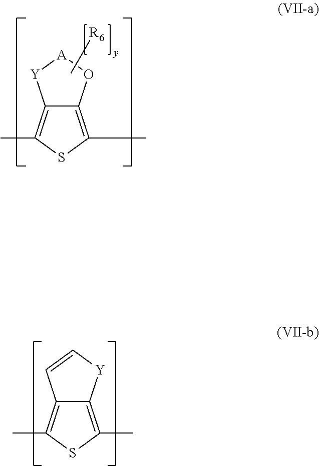

wherein
A represents an optionally substituted C₁-C₅ alkylene radical, preferably an optionally substituted C₂-C₃ alkylene radical,
Y represents O or S,
R₆ represents a linear or branched, optionally substituted C₁-C₁₈ alkyl radical, preferably linear or branched, optionally substituted C₁-C₁₈ alkyl radical, an optionally substituted C₅-C₁₂ cycloalkyl radical, an optionally substituted C₆-C₁₄ aryl radical, an optionally substituted C₇-C₁₈ aralkyl radical, an optionally substituted C₁-C₄ hydroxyalkyl radical or a hydroxyl radical,
y represents an integer from 0 to 8, preferably 0, 1 or 2, particularly preferably 0 or 1, and
if a plurality of radicals R₆ are bound to A, the radicals may be the same or different.

General formulae (VII-a) are to be understood as meaning that the substituent R₆ can be bound y times to the alkylene radical A.

In further most particularly preferred embodiments, polythiophenes containing recurring units of general formula (VII) are those containing recurring units of general formula (VII-aa) and/or of general formula (VII-ab)

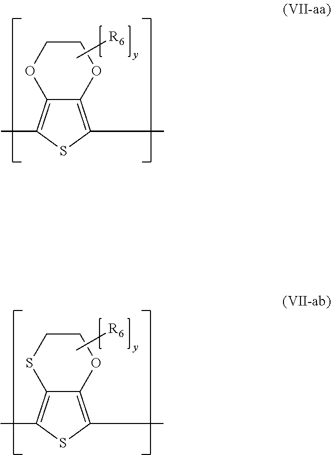

wherein
R₆ and y have the above-mentioned meaning.

In still further exceedingly preferred embodiments, polythiophenes containing recurring units of general formula (VII) are those containing polythiophenes of general formula (VII-aaa) and/or of general formula (VII-aba)

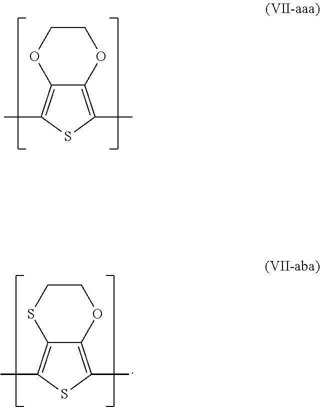

Within the scope of the invention, the prefix “poly” refers to the fact that more than one same or different recurring unit is contained in the polythiophene. The polythiophenes contain in total n recurring units of general formula (VII), wherein n can be an integer from 2 to 2,000, preferably 2 to 100. The recurring units of general formula (VII) can each be the same or different within a polythiophene. Polythiophenes each containing the same recurring units of general formula (VII) are preferred.

At the end groups, the polythiophenes preferably each carry H.

In particularly preferred embodiments, the polythiophene containing recurring units of general formula (I) is poly(3,4-ethylenedioxythiophene), poly(3,4-ethyleneoxythiathiophene) or poly(thieno[3,4-b]thiophene), i.e. a homopolythiophene made up of recurring units of formula (VII-aaa), (VII-aba) or (VII-b), in which Y═S.

In further particularly preferred embodiments, the polythiophene containing recurring units of general formula (VII) is a copolymer made up of recurring units of formula (VII-aaa) and (VII-aba), (VII-aaa) and (VII-b), (VII-aba) and (VII-b) or (VII-aaa), (VII-aba) and (VII-b), copolymers made up of recurring units of formula (VII-aaa) and (VII-aba) and also (VII-aaa) and (VII-b) being preferred.

C₁-C₅ alkylene radicals A are within the scope of the invention methylene, ethylene, n-propylene, n-butylene or n-pentylene, C₁-C₈ alkylene radicals are in addition n-hexylene, n-heptylene and n-octylene. C₁-C₈ alkylidene radicals are within the scope of the invention above-cited C₁-C₈ alkylene radicals containing at least one double bond. C₁-C₈ dioxyalkylene radicals, C₁-C₈ oxythiaalkylene radicals and C₁-C₈ dithiaalkylene radicals represent within the scope of the invention the C₁-C₈ dioxyalkylene radicals, C₁-C₈ oxythiaalkylene radicals and C₁-C₈ dithiaalkylene radicals corresponding to the above-cited C₁-C₈ alkylene radicals. C₁-C₁₈ alkyl, C₁-C₁₄ alkyl and C₅-C₁₂ cycloalkyl represent the corresponding selection from the above-cited C₁-C₂₀ alkyl and C₃-C₁₂ cycloalkyl respectively, C₁-C₁₈ alkoxy radicals represent within the scope of the invention the alkoxy radicals corresponding to the above-cited C₁-C₁₈ alkyl radicals, and C₆-C₁₄ aryl has the above-cited meaning. Furthermore, within the scope of the invention, C₇-C₁₈ aralkyl represents C₇-C₁₈ aralkyl radicals such as for example benzyl, o-, m-, p-tolyl, 2,3-, 2,4-, 2,5-, 2,6-, 3,4-, 3,5-xylyl or mesityl and the term “a C₁-C₄ hydroxyalkyl” refers within the scope of the invention to a C₁-C₄ alkyl radical having a hydroxy group as the substituent, and wherein the C₁-C₄ alkyl radical can for example be methyl, ethyl, n- or iso-propyl, n-, iso-, sec- or tert-butyl. The foregoing list serves to describe the invention by way of example and is not to be regarded as being exhaustive.

The optionally substituted polythiophenes are cationic, wherein the term “cationic” relates only to the charges sitting on the polythiophene main chain. Depending on the substituent on the radicals R, the polythiophenes can carry positive and negative charges in the structural unit, the positive charges being located on the polythiophene main chain and the negative charges optionally being located on the radicals R substituted by sulphonate or carboxylate groups. In this case, the positive charges of the polythiophene main chain can be partly or completely saturated by the optionally present anionic groups on the radicals R. Viewed globally, the polythiophenes may in these cases be cationic, neutral or even anionic. Nevertheless, they are all regarded within the scope of the invention as being cationic polythiophenes, as the positive charges on the polythiophene main chain are decisive. The positive charges are not represented in the formulae, as their precise number and position cannot be unobjectionably ascertained. However, the number of positive charges is at least 1 and at most n, wherein n is the total number of all (same or different) recurring units within the polythiophene.

In order to compensate for the positive charge, if this does not already take place as a result of the optionally sulphonate or carboxylate-substituted and thus negatively charged radicals R, the cationic polythiophenes require anions as counterions, wherein within the scope of the invention this role can be performed by the functionalised polysulphones.

The solids content of optionally substituted conductive polymer, in particular of an optionally substituted polythiophene containing recurring units of general formula (VII), is in the dispersion between 0.05 and 20.0 percent by weight (% by weight), preferably between 0.1 and 5.0% by weight, particularly preferably between 0.3 and 4.0% by weight.

The dispersions of the complex according to the invention can contain one or more dispersing agents. Examples of dispersing agents include the following solvents: aliphatic alcohols such as methanol, ethanol, i-propanol and butanol; aliphatic ketones such as acetone and methyl ethyl ketone; aliphatic carboxylic acid esters such as acetic acid ethyl ester and acetic acid butyl ester; aromatic hydrocarbons such as toluene and xylene; aliphatic hydrocarbons such as hexane, heptane and cyclohexane; chlorinated hydrocarbons such as dichloromethane and dichloroethane; aliphatic nitriles such as acetonitrile, aliphatic sulphoxides and sulphones such as dimethyl sulphoxide and sulpholane; aliphatic carboxylic acid amides such as methylacetamide, dimethylacetamide and dimethylformamide; aliphatic and araliphatic ethers such as diethyl ether and anisole. Furthermore, water or a mixture of water with the aforementioned organic solvents can also be used as the dispersing agent.

Preferred dispersing agents are water or other protic solvents such as alcohols, for example methanol, ethanol, i-propanol and butanol, and also mixtures of water with these alcohols, water being a particularly preferred solvent.

The total proportion of the complex according to the invention, i.e. of the optionally substituted conductive polymer, in particular of the optionally substituted polythiophenes containing recurring units of general formula (VII), and of the functionalised polysulphone, is in the dispersion for example between 0.05 and 10% by weight, preferably between 0.1 and 5% by weight based on the total weight of the dispersion.

The optionally substituted conductive polymer, in particular the optionally substituted polythiophene containing recurring units of general formula (VII), and the functionalised polysulphone can be contained in the dispersion in a ratio by weight of from 1:0.3 to 1:100, preferably from 1:1 to 1:40, particularly preferably from 1:2 to 1:20 and exceedingly preferably from 1:2 to 1:15. The weight of the conductive polymer corresponds in this case to the weighed-in portion of the monomers used, assuming that complete reaction takes place during the polymerisation.

The above-mentioned dispersion is produced in that firstly dispersions of electrically conductive polymers are produced in the presence of counterions from the corresponding precursors for the production of the optionally substituted conductive polymers, for example as under the conditions mentioned in EP-A 440 957. An improved variant for the production of these dispersions is the use of ion exchanger for removing the inorganic salt content or a part thereof. A variant of this type is for example described in DE-A 196 27 071. The ion exchanger can for example be mixed with the product or the product is conveyed via a column filled with ion exchanger. The use of the ion exchanger allows for example low metal contents to be achieved.

The particle size of the particles in the dispersion can be reduced after the desalination, for example by means of a high-pressure homogeniser. This process can also be repeated in order to heighten the effect. Particularly high pressures of between 100 and 2,000 bar have proven advantageous in this case in order to greatly reduce the particle size. Alternatively, the particle size can also be reduced by ultrasonic treatment.

Processes for producing the monomeric precursors for the production of the polythiophenes containing recurring units of general formula (VII), and also the derivatives thereof, are known to the person skilled in the art and described for example in L. Groenendaal, F. Jonas, D. Freitag, H. Pielartzik & J. R. Reynolds, Adv. Mater. 12 (2000) 481-494 and the literature cited therein. Mixtures of different precursors can also be used.

The term “derivatives of the above-cited thiophenes” refers in the sense of the invention for example to dimers or trimers of these thiophenes. Derivatives of higher molecular weight, i.e. tetramers, pentamers, etc., of the monomeric precursors are also possible as derivatives. The derivatives can be constructed of both the same and different monomer units and be used in pure form and also mixed with one another and/or with the thiophenes mentioned hereinbefore. In the sense of the invention, the term “thiophenes” and “thiophene derivatives” also includes oxidised or reduced forms of these thiophenes and thiophene derivatives, provided that the polymerisation thereof gives rise to the same conductive polymers as in the above-cited thiophenes and thiophene derivatives.

Particularly suitable monomeric precursors for the production of optionally substituted polythiophenes containing recurring units of general formula (VII) are optionally substituted 3,4-alkylenedioxythiophenes which can be represented by way of example by general formula (VIII)

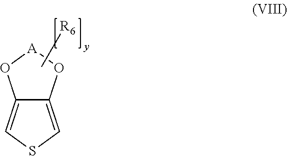

wherein A, R₆ and y have the above-mentioned meaning and wherein if a plurality of radicals R are bound to A, the radicals may be the same or different.

Most particularly preferred monomeric precursors are optionally substituted 3,4-ethylenedioxythiophenes, in a preferred embodiment unsubstituted 3,4-ethylenedioxythiophene. The dispersion can contain, in addition to the complex of conductive polymer and functionalised polysulphone, further polymers, for example polystyrene sulphonic acid, fluorinated or perfluorinated sulphonic acids, polyvinyl alcohols, polyvinyl pyrrolidones, polyvinyl chlorides, polyvinyl acetates, polyvinyl butyrates, polyacrylic acid esters, polyacrylic acid amides, polymethacrylic acid esters, polymethacrylic acid amides, polyacrylonitriles, styrene/acrylic acid ester, vinyl acetate/acrylic acid ester and ethylene/vinyl acetate copolymers, polyethers, polyesters, polyurethanes, polyamides, polyimides, non-functionalised polysulphones, melamine formaldehyde resins, epoxy resins, silicone resins or celluloses.

The dispersion can also contain further components such as surface-active substances, for example ionic and nonionic surfactants or adhesion promoters, such as for example organofunctional silanes or the hydrolysates thereof, for example 3-glycidoxypropyltrialkoxysilane, 3-aminopropyltriethoxysilane, 3-mercaptopropyltrimethoxysilane, 3-metacryloxypropyltrimethoxysilane, vinyltrimethoxysilane or octyltriethoxysilane.

Furthermore, within the scope of the invention, the dispersion can have a pH value in the range of from 1 to 8, preferably in the range of from 2 to 7, particularly preferably in the range of from 4 to 7. In order to set the appropriate pH value, bases such as amines, ammonium hydroxides or metal hydroxides, preferably ammonia or alkali hydroxides, can for example be added to the dispersions. In this regard, the pH value is determined at 25° C. with the aid of a pH electrode (Knick laboratory pH meter 766).

In addition, the complexes according to the invention are surprisingly suitable for the production of hole-injecting or hole-transporting layers in OLEDs or organic solar cells (OSCs), or for producing transparent conductive coatings.

Thus, a further subject matter of the present invention is the use of the complexes according to the invention for producing transparent conductive coatings or as a hole injection layer or hole transport layers in organic light emitting diodes (OLEDs) or organic solar cells (OSCs).

For producing the transparent conductive coatings, the above-mentioned dispersions are for example applied using known processes, for example by spin coating, impregnation, pouring, dropping-on, injection, spraying-on, doctoring-on, brushing or imprinting, for example inkjet, screen, gravure, offset or pad printing, to a suitable underlay at a wet film thickness of from 0.5 μm to 250 μm, preferably at a wet film thickness of from 2 μm to 50 μm and subsequently dried at least a temperature of from 20° C. to 200° C.

Organic light emitting diodes (OLEDs) are becoming increasingly important in applications such as displays and flat top antennas. The construction and the function of OLEDs are known to the person skilled in the art and have been widely described, such as for example in D. Hertel and K. Meerholz, Chemie unserer Zeit, 39 (2005) 336-347. The complexes according to the invention may be used as intermediate layers in these applications.

Thus, for example, the following construction is conceivable: A transparent electrically conductive electrode, such as for example made of indium tin oxide (ITO), doped zinc or tin oxide or a conductive polymer, such as for example presented above, is applied to the transparent substrate made of glass, PET or other transparent plastics materials. The complexes according to the invention are deposited thereon as a thin layer. Subsequently, one or more organic functional layers are applied thereto. These may be conjugated polymers such as polyphenylene vinylene or polyfluorenes or layers of vapour-deposited molecules such as are known to the person skilled in the art and such as are described for example by D. Hertel and K. Meerholz, Chemie unserer Zeit, 39 (2005) 336-347. The OLED is completed by deposition of a final metal electrode, such as for example metallic barium LiF//Al. On application of the DC voltage of from 2-20 V, a current flows through the arrangement and electroluminescence is generated in at least one of the functional layers.

The advantages of polymeric intermediate layers in OLEDs are:
1.) Simple separation of the polymeric intermediate layer from the solution without a time-consuming and costly vacuum process.
2.) The polymeric intermediate layer is highly transparent and allows efficient decoupling of light.
3.) A polymeric intermediate layer smooths the underlying layer. This causes fewer short circuits in the fully processed OLED and thus higher yields in the manufacture of components.
4.) Improved electrical properties of the OLEDs as a result of improved injection of the charge carriers from the transparent electrode into the following organic layers.

The complexes according to the invention may also be used in a similar manner for producing organic solar cells (OSCs), where they lead to similar advantages. In OSCs, a voltage is generated as a result of the fact that the electrodes absorb light. The construction is known to the person skilled in the art and has been widely described, such as for example in S. Sensfuss et al. Kunststoffe 8, (2007), 136.

The following examples serve merely to describe the invention by way of example and are not to be interpreted as entailing limitation.

### EXAMPLES

### Example 1

### (According to the Invention): Production of a Dispersion of PEDOT and s-PPS

A 3-l glass vessel was equipped with a stirrer and a thermometer. 1,456 g of water, 1,073 g of an aqueous solution of sulphonated polysulphone (polysulphone SLA 3405—solution of the polysulphone SLA 340, from Fumatech, St. Ingbert, Germany, polysulphone content 4.6%, equivalent weight=340 g/mol, M_{w}=29,000 g/mol), 4.97 g of a 10% solution of iron (III) sulphate in water and also 4.12 g of ethylenedioxythiophene, EDT (Clevios M V2, H. C. Starck Clevios GmbH, Germany) were stirred thoroughly in the glass vessel at 25° C. for 15 minutes (min.). 9.44 g of sodium peroxodisulphate were added and the mixture was stirred for 24 hours (h) at 25° C. Subsequently, 180 ml of anion exchanger (Lewatit MP 62, Lanxess, Leverkusen, Germany) and 300 ml of cation exchanger (Lewatit S100 H, Lanxess, Leverkusen, Germany) were added. The mixture was stirred for 2 h. Subsequently, the ion exchanger was separated-off through a paper filter and the dispersion was passed through a 0.2 μm

Solids content: 1.68%
pH value 2 (Knick laboratory pH meter 766).
Sodium content 170 ppm
Sulphate content 6 ppm
Viscosity 2 mPas (Haake RV 1, 20° C., 700 s-l)

### Example 2

### (According to the Invention): Production of Layers Based on the PEDOT/s-PPS Complex

A cleaned glass substrate was placed onto a spin coater and 10 ml of the dispersion described in Example 1 were distributed on the substrate. Subsequently, the supernatant dispersion was centrifuged-off by rotating the plate. Afterwards, the substrate coated in this way was dried on a heating plate for 3 min at 200° C. The layer thickness was 75 nm (Tencor, Alphastep 500). The conductivity was determined in that Ag electrodes having a length of 2.5 cm were vapour-deposited at a spacing of 0.5 mm via a shadow mask. The surface resistance, which was determined using an electrometer, was multiplied by the layer thickness in order to obtain the electrical specific resistance. The specific resistance of the layer was 2,910 ohms·cm. The layer was transparent.

### Example 3

### Reference Example

The pH value of a PEDOT:PSSA dispersion having a 1.6% content (Clevios™ P VP AI 4083, H.C. Starck Clevios GmbH, Germany) was determined with the aid of a pH electrode (Knick laboratory pH meter 766). The pH value was 1.5.

Example 3 shows that the dispersion produced in Example 1 has a higher pH value than the standard material Clevios™ P VP AI 4083.

### Example 4

### (According to the Invention): Storage at Elevated Temperature

50 g of the dispersion from Example 1 were stored for 16 days at 50° C. After storage the sulphate content was 7 ppm. The sulphate concentration thus remained unaltered within the limits of experimental accuracy. The complex produced does not lose any sulphate when exposed to a temperature of 50° C.

### REFERENCES

A PEDOT:PSSA dispersion (Clevios™ P VP AI 4083, H.C. Starck Clevios GmbH) having the following properties was used for a reference test:
Solids content 1.6%
Sulphate content 5 ppm
pH value 1.5

50 g of this material were likewise stored for 16 days at 50° C. After storage the sulphate content was 22 ppm and had thus risen markedly.

Example 4 shows that the dispersion according to the invention from Example 1, in contrast to the known PEDOT:PSSA complex, does not lose any sulphate at elevated temperature.

### Example 5

### (According to the Invention): Production of an OLED

The dispersion according to the invention from Example 1 was used to construct organic light emitting diodes (OLEDs). The procedure was as follows in the production of the OLEDs:

### 1. Preparation of the ITO-Coated Substrate

ITO-coated glass was cut into 50 mm×50 mm-sized pieces (substrates) and structured with photoresist into four parallel lines—each having a width of 2 mm and a length of 5 cm. Afterwards, the substrates were cleaned in an ultrasonic bath in a 0.3% Mucasol solution, rinsed with distilled water and dry centrifuged in a centrifuge. Immediately before the coating, the ITO-coated sides were cleaned in a UV/ozone reactor (PR-100, UVP Inc., Cambridge, GB) for 10 min.

### 2. Application of the Hole-Injecting Layer

About 5 ml of the dispersion according to the invention from Example 1 were filtered (Millipore HV, 0.45 μm). The cleaned ITO-coated substrate was placed onto a spin coater and the filtered solution was distributed on the ITO-coated side of the substrate. Subsequently, the supernatant solution was centrifuged-off by rotating the plate at 1,400 rpm over a period of time of 30 seconds (s). Afterwards, the substrate coated in this way was dried on a heating plate for 5 min. at 200° C. The layer thickness was 50 nm, measured using a profilometer (Tencor, Alphastep 500).

### 3. Application of the Hole Transport and the Emitter Layer

The ITO substrates coated with the dispersion from Example 1 were transferred to a vapour deposition installation (Univex 350, Leybold). At a pressure of 10⁻³ Pa firstly 60 nm of a hole transport layer made of NPB (N,N-bis(naphthalen-1-yl)-N,N′-bis(phenyl)benzidine) and then 50 nm of an emitter layer made of AlQ₃ (tris-(8-hydroxyquinoline) aluminium) were successively vapour-deposited at a vapour deposition rate of 1 Å/sec.

### 4. Application of the Metal Cathode

Subsequently, the layer system was transferred to a glove box system containing an N₂ atmosphere and an integrated vapour deposition installation (Edwards) and vaporised with metal electrodes. For this purpose, the substrate was brought with the layer system down onto a shadow mask. The shadow mask contained 2 mm-wide rectangular slots which intersect the ITO strips and were oriented perpendicularly thereto. A 0.5 nm-thick LiF layer and subsequently a 200 nm-thick Al layer were successively vapour-deposited from two vapour deposition boats at a pressure of p=10⁻³ Pa. The vapour deposition rates were 1 Å/s for LiF and 10 Å/s for Al. The surface area of the individual OLEDs was 4.0 mm².

### 5, Characterisation of the OLED

The two electrodes of the organic LED were connected (contacted) to a voltage source via electrical feeds. The positive pole was connected to the ITO electrode and the negative pole was connected to the metal electrode. The dependency of the OLED current and the electroluminescence intensity (this is demonstrated using a photodiode (EG&G C30809E)) on the voltage was recorded. Subsequently, the useful life was determined in that a constant current of I=1.92 mA is passed through the arrangement, and the voltage and light intensity were monitored as a function of time.

### Example 6

### (Reference): Production of an OLED

The procedure is as in Example 5 with the difference that in the 2^{nd} process step the intermediate layer used was not the dispersion according to the invention from Example 1, but the Clevios™ P VP A14083 (H.C. Starck Clevios GmbH) which is used as standard in OLED construction. For this purpose, AI4083 was filtered and centrifuged at 1,100 rpm for 30 sec and subsequently dried on a heating plate at 200° C. for 5 min. The layer thickness was 50 nm and the specific resistance was 1,150 ohms·cm.

### Example 7

### (Reference): Production of an OLED

The procedure is as in Examples 5 and 6 with the difference that the polymeric intermediate layer was dispensed with altogether and the 2^{nd} process step is omitted.

### Example 8

### Comparison of the OLEDs from Examples 5, 6 and 7

In order to demonstrate the improvement of the OLEDs containing the dispersion according to the invention from Example 1 over the standard material Clevios™ P VP AI4083, 1 substrate from each of Examples 5, 6 and 7 was processed in parallel, i.e. the vapour deposition layers and cathodes were deposited onto all the substrates under identical conditions. The OLEDs produced in accordance with Examples 5 and 6 displayed the typical diode behaviour of organic light emitting diodes. The superstructures produced in accordance with Example 7, on the other hand, all displayed electrical short circuits.

The useful life measurements evaluate the voltage and luminance at the point in time t=0, U0 or L0, the current efficiency as a quotient L0/I, the time until the luminance has dropped to 50% of L0, t @ L0/2, and the voltage at the time t @ L0/2.

| | Useful life of the ITO//HIL//NPB//ALQ//LiF//Al-OLEDs | | | | |
|---|---|---|---|---|---|
| | @ I = 48 mA/cm | | | | |
| | U0 | L0 | Efficiency | t @ L0/2 | U(t@L0/2) |
| | [V] | [cd/m²] | [cd/A] | [h] | [V] |
| OLED from | 5.0 | 1,100 | 2.3 | 344 | 6.5 |
| Example 5 | | | | | |
| (according to | | | | | |
| the invention) | | | | | |
| OLED from | 5.2 | 1,100 | 2.3 | 30 | 6.1 |
| Example 6 | | | | | |
| (reference) | | | | | |

| | |
|---|---|
| OLED from | No useful life measurements possible owing |
| Example 7 | to electrical short circuits |
| (reference) | |

It has thus been demonstrated that a polymeric intermediate layer is necessary for short circuit-free OLEDs. The dispersion according to the invention from Example 1 as an intermediate layer in OLEDs has the major advantage of an approx. 10-fold useful life with a reduced rise in voltage compared to the standard material Clevios P AI4083.

### Example 9

### (According to the Invention): Neutralisation of the Dispersion from Example 1

Ammonia was added to the dispersion according to the invention from Example 1 while stirring continuously until a pH value of approx. 6 was set.

### Example 10

### (According to the Invention): Production of an OLED

The procedure is as in Example 5 with the difference that the neutralised form of the formulation according to the invention corresponding to Example 9 was used in the 2nd process step. For this purpose, the solution from Example 9 was filtered and centrifuged at 1,500 rpm for 30 sec and subsequently dried on a heating plate at 200° C. for 5 min. The layer thickness was 50 nm.

### Example 11

### (According to the Invention): Production of an OLED

For comparison, an OLED was processed as in Example 5. For this purpose, the solution from Example 1 was filtered and centrifuged at 1,400 rpm for 30 sec and subsequently dried on a heating plate at 200° C. for 5 min. The layer thickness was 50 nm.

### Example 12

### Comparison of the OLEDs from Examples 10 and 11

The OLED useful life test was carried out and the data were evaluated as in Example 8 with the one difference that the point in time of the drop in luminescence not to 50%, but to 80%, of the initial intensity was evaluated.

| | Useful life of the ITO//HIL//NPB//ALQ//LiF//Al-OLEDs | | | | |
|---|---|---|---|---|---|
| | @ I = 48 mA/cm | | | | |
| | U0 | L0 | Efficiency | t @ 80% L0 | U(t@80% L0) |
| | [V] | [cd/m²] | [cd/A] | [h] | [V] |
| OLED from | 5.0 | 1,140 | 2.4 | 275 | 6.5 |
| Example 10 | | | | | |
| (according to | | | | | |
| the invention) | | | | | |
| OLED from | 5.2 | 1,180 | 2.5 | 90 | 6.1 |
| Example 11 | | | | | |
| (according to | | | | | |
| the invention) | | | | | |

This shows that the neutralised form of the solution according to the invention leads to advantages with respect to the useful life of the OLED.

### Example 13

### (According to the Invention): Determining the Contact Angle

As in Example 5 point 2, layers of the dispersion according to the invention from Example 1 were deposited onto glass substrates with the aid of a spin coater and dried on a heating plate at 200° C. for 5 min. Subsequently, the angle of contact of a drop of toluene placed on the layer with the layer was determined (Krüss MicroDrop). The contact angle was 5.5°.

### Example 14

### (Reference): Determining the Contact Angle

As in Example 13, the angle of contact of a layer of the reference material Clevios™ P VP AI4083 with toluene was determined: α=4.2°

### Example 15

### (Reference) Determining the Contact Angle

As in Example 13, the angle of contact of a layer of the reference material corresponding to EP 1564250, i.e. a mixture of perfluorinated sulphonic acid polymers, with conductive polymers was determined: α=48°.

Examples 13-15 reveal that the wetting of layers consisting of the formulation according to the invention with toluene-based solutions is similarly good as for Clevios™ P AI4083, but is much better than for the reference material corresponding to EP 1564250.

### Example 16

### (Not According to the Invention): Production of Sulphonated Polyether Sulphone

50.0 g of polyether sulphone Ultrason E 1010® (supplier: BASF SE) were added to 500.00 g of 95% sulphuric acid. The mixture was heated for 4 h to 120° C. while stirring intensively. Afterwards, the reaction mixture was cooled to 23° C. and stirred-in at this temperature while being cooled in 2.5 l of water and 750 ml of n-butanol were subsequently added. The butanol phase was washed twice with 200 ml of water each time and the washing water was discarded. The aqueous phase was extracted with 100 ml of n-butanol. Afterwards, the combined butanol phases were washed twice with 200 ml of water each time and the washing water was discarded. The butanol phase was neutralised with 30% NaOH to a pH value of approx. 6.5, Subsequently, the aqueous phase was concentrated and the solid residue was mixed with 1 l of methanol. The non-dissolved sodium sulphate was filtered out. The filtrate was evaporated again and the residue was dissolved in 700 ml of water. This solution was treated 3× with ion exchanger (Lewatit MP® 62 and Lewatit® Monoplus S 100, supplier: Lanxess AG) to remove sulphate and sodium ions and subsequently evaporated to dryness and also after-dried at 0.5 mbar/80° C. Yield: 42 g of s-PES. Degree of sulphonation per repeating unit of the polymer=0.90 in accordance with titration with 0.1 N sodium hydroxide solution.

### Example 17

### (According to the Invention): Production of a Dispersion of PEDOT and Sulphonated Polyether Sulphone

A 2-l glass vessel was equipped with a stirrer and a thermometer. 1,108 g of water, 18.97 g of the sulphonated polyether sulphone from Example 16, 1.92 g of a 10% solution of iron (III) sulphate in water and also 1.58 g of ethylenedioxythiophene, EDT (Clevios M V2, H.C. Starck Clevios GmbH, Germany) were stirred thoroughly in the glass vessel at 25° C. for 15 minutes (min.). 3.857 g of sodium peroxodisulphate were added and the mixture was stirred for 24 hours (h) at 25° C. Subsequently, 47 g of anion exchanger (Lewatit MP 62, Lanxess, Leverkusen, Germany) and 92 g of cation exchanger (Lewatit S100 H, Lanxess, Leverkusen, Germany) were added. The mixture was stirred for 2 h. Subsequently, the ion exchanger was separated off through a paper filter and the dispersion was passed through a 0.2 μm filter.

Solids content: 0.96%
Viscosity 2 mPas (Haake RV 1, 20° C., 700 s-l)

### Example 18

### (According to the Invention): Production of Layers Based on the PEDOT Complex and Sulphonated Polyether Sulphone

A cleaned glass substrate was placed onto a spin coater and 10 ml of the dispersion described in Example 17 were distributed on the substrate. Subsequently, the supernatant dispersion was centrifuged off by rotating the plate. Afterwards, the substrate coated in this way was dried on a heating plate for 3 min at 200° C. The layer thickness was 62 nm (Tencor, Alphastep 500). The conductivity was determined in that Ag electrodes having a length of 2.5 cm were vapour-deposited at a spacing of 0.5 mm via a shadow mask. The surface resistance, which was determined using an electrometer, was multiplied by the layer thickness in order to obtain the electrical specific resistance. The specific resistance of the layer was 1900 ohms·cm. The layer was transparent.

1-12. (canceled)

13. A complex comprising at least one optionally substituted conductive polymer and at least one functionalised polysulphone, wherein the polysulphone is a polymer which contains an —SO₂ group in its repeating units and in which this sulphone group is linked to two aromatic groups.

14. The complex according to claim 13, wherein the functionalised polysulphone contains recurring units of general formula (I): 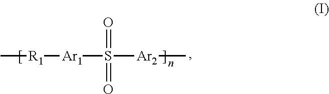
wherein
A₁ and A₂ may be the same or different, and are optionally substituted aromatics,
R₁ is an optionally substituted organic radical containing 0 to 80 carbon atoms or —SO₂— or —O— and
n is an integer from 5 to 50,000.

15. The complex according to claim 13, wherein the functionalised polysulphone contains recurring units of general formula (II) 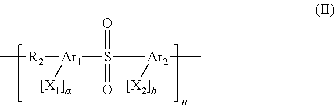
wherein
Ar₁ and Ar₂ are the same or different, and represent an aromatic,
X₁ and X₂ are the same or different and each represent a sulphonic acid, phosphonic acid, carboxylic acid, sulphonate, phosphonate or carbonate group,
a and b are the same or different, and each independently of one another represent an integer or non-integer between 0 and 2,
R₂ is an optionally substituted organic radical containing 0 to 80 carbon atoms or —SO₂— or —O— and
n is an integer from 5 to 50,000.

16. The complex according to claim 13, wherein the functionalised polysulphone contains recurring units of general formula (IIa) 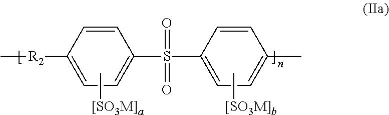
wherein
a and b are the same or different, and each independently of one another represent an integer or non-integer between 0 and 2,
R₂ is an optionally substituted organic radical containing 0 to 80 carbon atoms or —SO₂— or —O— and
M represents a metal cation or H.

17. The complex according to claim 13, wherein the functionalised polysulphone contains recurring units of general formula (III) 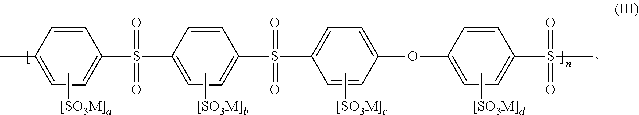
of general formula (IV) 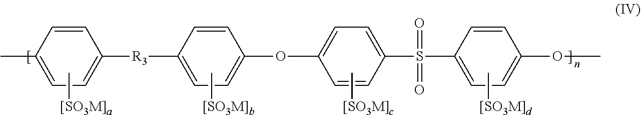
of general formula (V) 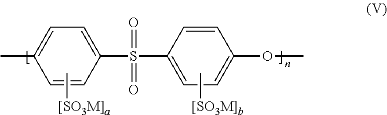
or of general formula (VI) 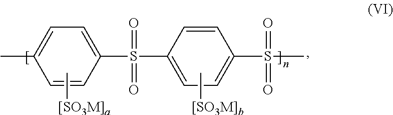
wherein
a, b, c and d are the same or different, and each represent an integer or non-integer between 0 and 1,
M represents a metal cation or H,
R₃ represents an alkylidene radical, and
n is an integer from 5 to 50,000.

18. The complex according to claim 13, wherein the conductive polymer is optionally substituted polythiophenes containing recurring units of general formula (VII), 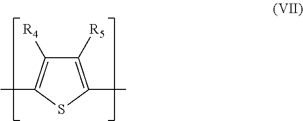
wherein
R₄ and R₅ each independently of one another represent H, an optionally substituted C₁-C₁₈ alkyl radical or an optionally substituted C₁-C₁₈ alkoxy radical, R₃ and R₄ together represent an optionally substituted C₁-C₈ alkylene radical, wherein one or more C atom(s) can be replaced by one or more same or different heteroatoms selected from O or S, or an optionally substituted C₁-C₈ alkylidene radical, wherein optionally at least one C atom is replaced by a heteroatom selected from O or S.

19. The complex according to claim 13, wherein the conductive polymer is optionally substituted polythiophenes containing recurring units of general formula (VII), 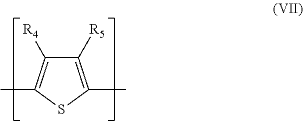
wherein
R₄ and R₅ each independently of one another represent H, an optionally substituted C₁-C₁₈ alkyl radical or an optionally substituted C₁-C₁₈ alkoxy radical, R₃ and R₄ together represent a C₁-C₈ dioxyalkylene radical, an optionally substituted C₁-C₈ oxythiaalkylene radical or an optionally substituted C₁-C₈ dithiaalkylene radical, or an optionally substituted C₁-C₈ alkylidene radical, wherein optionally at least one C atom is replaced by a heteroatom selected from O or S.

20. The complex according to claim 18, wherein the polythiophene contains recurring units of general formula (VII-a) and/or (VII-b) 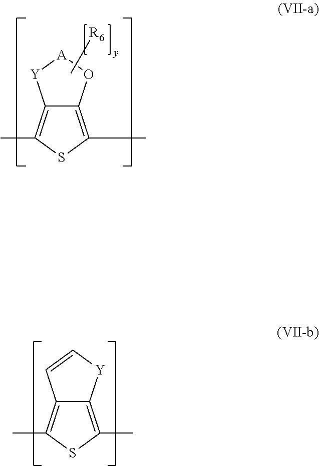
wherein
A represents an optionally substituted C₁-C₅ alkylene radical, preferably an optionally substituted C₂-C₃ alkylene radical,
Y represents O or S,
R₆ represents a linear or branched, optionally substituted C₁-C₁₈ alkyl radical, an optionally substituted C₅-C₁₂ cycloalkyl radical, an optionally substituted C₆-C₁₄ aryl radical, an optionally substituted C₇-C₁₈ aralkyl radical, an optionally substituted C₁-C₄ hydroxyalkyl radical or a hydroxyl radical,
y represents an integer from 0 to 8, and
if a plurality of radicals R are bound to A, the radicals may be the same or different.

21. Complex according to claim 20, wherein the polythiophene is poly(3,4-ethylenedioxythiophene).

22. The complex according to claim 13, wherein the complex comprises one or more dispersing agents.

23. Complex according to claim 21, characterised in that the dispersion has a pH value in a range of from 1 to 8.

24. A process for producing transparent, conductive coatings which comprises utilizing the complex according to claim 13.

25. A process for producing hole injection or hole transport layers in organic light emitting diodes or organic solar cells which comprises utilizing the complex according to claim 13.
